(19) United States
(12) Patent Application Publication
(10) Pub. No.: US 2018/0091527 A1
(43) Pub. Date: Mar. 29, 2018

(54) EMULATING NETWORK TRAFFIC

(71) Applicants: Sasi Siddharth Muthurajan, Cambridge, MA (US); Barak Raz, Sunnyvale, CA (US)

(72) Inventors: Sasi Siddharth Muthurajan, Cambridge, MA (US); Barak Raz, Sunnyvale, CA (US)

(73) Assignee: HEWLETT PACKARD ENTERPRISE DEVELOPMENT LP, Houston, TX (US)

(21) Appl. No.: 15/280,954

(22) Filed: Sep. 29, 2016

(51) Int. Cl. H04L 29/06

(52) U.S. Cl. CPC H04L 63/145; H04L 63/1416

(57) ABSTRACT

Examples relate to emulating network traffic. In one example, a computing device may receive malware data specifying a malware feature; emulate a plurality of host computing devices; generate benign network traffic for each of the plurality of host computing devices; for a particular host device of the plurality of host devices, generate malicious network traffic based on the malware data; and cause transmission of the benign network traffic and the malicious network traffic.

### BACKGROUND

Networks of computing devices are often protected from malicious attacks using a variety of methods. Different devices and processes may be used to detect, identify, prevent, and remediate the effects of different types of malware. For example, some devices may analyze network traffic as it is transmitted through various devices of a computing network, looking for malicious signatures and patterns that might indicate a compromised computing device.

### BRIEF DESCRIPTION OF THE DRAWINGS

The following detailed description references the drawings, wherein:

FIG. 1 is a block diagram of an example computing device for emulating network traffic.

FIG. 2 is an example data flow depicting the emulation of network traffic.

FIG. 3 is a flowchart of an example method for emulating network traffic.

FIG. 4 is a flowchart of an example method for the emulation of network traffic.

### DETAILED DESCRIPTION

The ability to emulate network traffic may facilitate determining the effectiveness of various forms of network security, and may enable a variety of different types of network-related testing, such as the testing of network load balancing, intrusion detection, intrusion prevention, and malware mitigation. For example, the effectiveness of various types of malware prevention, detection, and remediation devices may be evaluated by emulating and transmitting both malicious and benign network traffic, e.g., in a manner designed to emulate an enterprise network with one or more infected devices.

By way of example, a network traffic emulator may emulate multiple computing devices by spoofing IP addresses. Benign network traffic, e.g., network traffic known to be non-malicious, may be transmitted by the emulator to various destinations using network packets and spoofed IP addresses to emulate the computing devices. The network traffic emulator may also generate malicious network traffic for at least one of the emulated computing devices. The type of malicious network traffic may vary, e.g., based on user input or according to an automated testing schedule. The network traffic emulator may transmit the malicious network traffic along with the benign network traffic in a manner designed to emulate a network of computing devices with at least one malware-infected device. By emulating an infected network of computing devices, the efficacy of various testing devices that are designed to protect a network may be evaluated. Further details regarding the emulation of network traffic are provided in the paragraphs that follow.

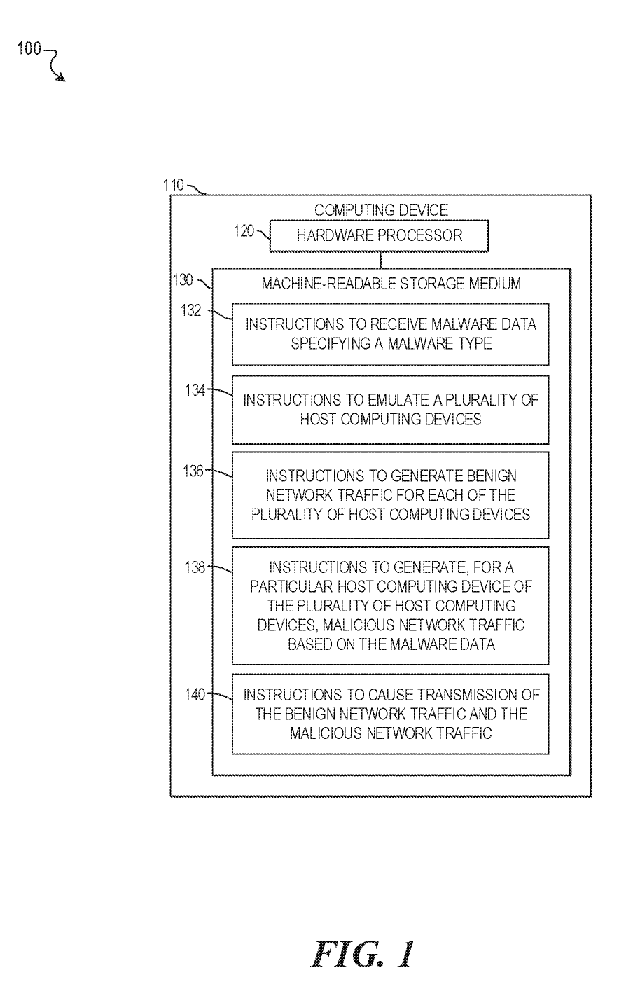

Referring now to the drawings, FIG. 1 is a block diagram 100 of an example computing device 110 for emulating network traffic. Computing device 110 may be, for example, a personal computer, a server computer, cluster of computers, or any other similar electronic device capable of processing data. In the example implementation of FIG. 1, the computing device 110 includes a hardware processor, 120, and machine-readable storage medium, 130.

Hardware processor 120 may be one or more central processing units (CPUs), semiconductor-based microprocessors, and/or other hardware devices suitable for retrieval and execution of instructions stored in machine-readable storage medium, 130. Hardware processor 120 may fetch, decode, and execute instructions, such as 132-140, to control processes for emulating network traffic. As an alternative or in addition to retrieving and executing instructions, hardware processor 120 may include one or more electronic circuits that include electronic components for performing the functionality of one or more instructions, e.g., a Field Programmable Gate Array (FPGA) or Application Specific Integrated Circuit (ASIC).

A machine-readable storage medium, such as 130, may be any electronic, magnetic, optical, or other physical storage device that contains or stores executable instructions. Thus, machine-readable storage medium 130 may be, for example, Random Access Memory (RAM), non-volatile RAM (NVRAM), an Electrically Erasable Programmable Read-Only Memory (EEPROM), a storage device, an optical disc, and the like. In some implementations, storage medium 130 may be a non-transitory storage medium, where the term “non-transitory” does not encompass transitory propagating signals. As described in detail below, machine-readable storage medium 130 may be encoded with executable instructions: 132-140, for emulating network traffic.

As shown in FIG. 1, the hardware processor 120 executes instructions 132 to receive malware data specifying a malware feature. Malware data may be received from a variety of sources including, for example, user input or a database of malware data. The malware feature specified by the malware data may include or indicate the type of attack that will be emulated by the computing device 110. For example, the malware feature may include a domain generation algorithm (DGA). A DGA is a tool used by some types of malware to spread, avoid detection, and obtain data from a third party server device by sending domain name server (DNS) requests to domain names that were generated using a DGA. Another malware feature includes data exfiltration, which is a type of attack that may exfiltrate data in a variety of ways. The malware data may specify other features of malware that can be emulated by the computing device 110. In some implementations, the malware data may specify multiple features of malware. Multiple features of malware may, for example, be emulated concurrently, or separately, and on the same or different emulated computing devices of a network being tested.

In some implementations, the malware data includes a variety of information that enables the computing device 110 to emulate a certain type of attack or malware. For example, the malware data may include a number of network computing devices to be emulated, a number of infected devices, an amount of benign traffic to be emulated, an amount of malicious traffic to be emulated, a transmission pattern for benign traffic, a transmission pattern for malicious traffic, a type of benign traffic, and/or a type of malicious traffic. By way of example, malware data included in a malware data database may specify a data exfiltration type of attack with two infected computing devices and 100 non-infected computing devices and 5 gigabits per hour of network traffic transmitted in a pseudo-random manner.

The hardware processor 120 executes instructions 134 to emulate a plurality of host computing devices. The host computing devices may be any computing devices capable of processing data. Host computing devices may also be capable of transmitting data over a network. Example host computing devices include client computers, server computers, mobile computing devices, routing devices, and switches. Host computing devices may be emulated in a variety of ways. For example, a spoofed IP address may be created for each emulated host computing device. The spoofed IP address may be used by the computing device 110 to transmit network traffic in a manner that is designed to make the network traffic appear as though it were transmitted by a device associated with the spoofed IP address. Other forms of emulation may be used, e.g., spoofing other types of computing device identifiers or information and/or using virtual machines to emulate host computing devices.

The hardware processor 120 executes instructions 136 to generate benign network traffic for each of the plurality of host computing devices. The benign network traffic may be generated in a variety of ways. In some implementations, a benign traffic model is used to generate the benign network traffic. The benign traffic model may be based on previously recorded network traffic. For example, network traffic for an enterprise network may be recorded, and a model may be built to regenerate the same network traffic that was previously recorded. In some implementations the benign traffic model may be generated using a different type of model, e.g., a model that generates traffic from a whitelist of benign network traffic.

The hardware processor 120 executes instructions 138 to generate, for a particular host computing device of the plurality of host computing devices, malicious network traffic based on the malware data. As with the benign network traffic, the malicious network traffic may be generated in a variety of ways. In some implementations, a malicious traffic model is used to generate the malicious network traffic. For example, malicious network activity that previously occurred on an enterprise network may be recorded, and a model may be built to regenerate the same network traffic that was previously recorded. In some implementations other types of malicious traffic models may be used. For example, a blacklist may be used to generate malicious traffic, e.g., network traffic addressed to domains known to be malicious or network traffic with a payload known to match a malicious payload. As another example, a known malicious algorithm may be used to generate malicious network traffic. For example, a DGA may be used to generate DNS requests to randomly generated domains.

The hardware processor 120 executes instructions 140 to cause transmission of the benign network traffic and the malicious network traffic. As with the generation of the network traffic, both the benign and malicious network traffic may be transmitted in a variety of ways, e.g., using traffic transmission models, Some transmission models cause transmission of network traffic in a manner designed to emulate actual traffic transmission patterns of a real network. In some implementations, the transmission patterns of previously recorded benign traffic may be used to transmit emulated benign network traffic, and transmission patterns of previously recorded malicious traffic may be used to transmit emulated malicious network traffic. In some implementations, traffic transmission models may transmit network traffic in accordance with predetermined rules or parameters, e.g., causing a particular amount of network traffic to be transmitted over a particular amount of time, adding variance in the amount of traffic being transmitted over any given period of time, changing distribution patterns using randomization or a Poisson distribution model, and other forms of model variations and parameters.

The emulated network traffic produced by the computing device 110 is, in the examples above, designed to emulate an infected network, where one or more of the emulated devices are infected with some type of malware. The network traffic may be monitored, during and/or after transmission, by malware detection, prevention, and/or remediation device(s) that attempt to identify malware in the emulated network. In this situation, the emulated network traffic may be used to determine how effective various devices are at identifying, preventing, or remediating malware on a network. In some situations, other types of devices may also be tested. For example, a load balancing device and/or router may be tested on how it handles load balancing network traffic during a malware infection.

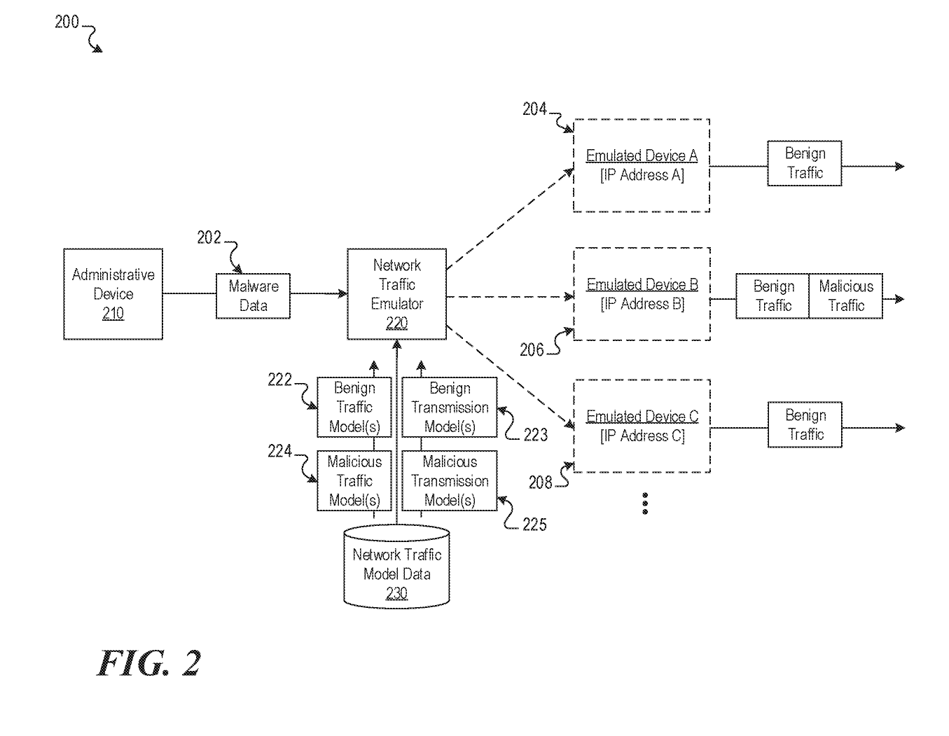

FIG. 2 is an example data flow 200 depicting the emulation of network traffic. The data flow 200 includes an administrative device 210, a network traffic emulator 220, and network traffic model data 230. The network traffic emulator 220 may be the same as or similar to the computing device 110 of FIG. 1. The administrative device 210 may be any computing device capable of communicating with the network traffic emulator 220, and the administrative device 210 may, in some implementations, be an input device that enables a user to communicate with the network traffic emulator 220. The network traffic model data 230 is a data storage device for storing both benign and malicious traffic model data that may be used by the network traffic emulator 220 to emulate network traffic.

During operation, the administrative device 210 provides malware data 202 to the network traffic emulator 220. The malware data 202 may include a variety of information, such as a malware feature, a number of computing devices to be emulated, a number of infected computing devices, and other parameters. In some implementations the malware data 202 may also include a benign and/or malicious traffic models for generating and/or transmitting benign and/or malicious network traffic. The malware data 202 may, in some implementations, include parameters to be used as input to one or more traffic models, e.g., a traffic volume or distribution pattern.

The network traffic emulator 220 emulates multiple devices, e.g., emulated devices A 204, B 206, and C 208. As noted above the manner in which devices are emulated may vary. The network traffic emulator 220 may, for example, generate an IP address for each device to be emulated. Other data, such as a device type, may also be associated with the IP address to form an emulated device. As another example, the network traffic emulator 220 may instantiate virtual machines as emulated devices, each with its own IP address. The number and type of emulated devices that are generated by the network traffic emulator 220 may vary, and may be based on information included in the malware data 202, e.g., a number of devices that is specified by user input.

In the example data flow, the network traffic emulator 220 obtains benign traffic model(s) 222, benign transmission model(s) 223, malicious traffic model(s) 224, and malicious transmission model(s) 225 from the network traffic model data 230. The benign traffic model(s) 222 may include a model for generating benign network traffic and a benign transmission model(s) may include a model for transmitting the benign network traffic. By way of example, the benign traffic model 222 may include data specifying a pattern of previously recorded benign network traffic for one or more computing devices. An example benign transmission model 223 may be a Poisson distribution model based on previously recorded benign network traffic. The malicious traffic model(s) 224 may include a model for a particular feature or type of malware, such as a DGA for generating DNS requests in a manner similar to that of a malware searching for a command and control server. Another example malicious traffic model may be a model for generating local port scan traffic in a manner similar to that of malware searching for a way to spread within a computing network. An example malicious traffic transmission model 225 may also be a Poisson distribution model based on previously recorded malicious network traffic. Other transmission models may also be used, for both benign and malicious network traffic.

In some implementations, multiple models may be used for benign and/or malicious network traffic. For example, the malware data 202 may specify multiple different features of attacks or malware, for which multiple malicious models may be used, e.g., one malicious model for each attack feature specified by the malware data 202.

The network traffic emulator 220 uses the benign and malicious traffic models to generate benign network traffic for each of the emulated computing devices and malicious network traffic for at least one of the emulated devices. In the example data flow 200, the network traffic emulator 220 generates benign traffic for emulated devices A 204, B 206, C, 208, and so on, while malicious traffic is only generated for emulated device B 206. As noted above, the number of infected devices may vary, and in some implementations the network traffic emulator 220 emulates malicious traffic for multiple emulated devices, e.g., to emulate multiple infected computing devices. In some implementations, multiple types of malicious traffic may be generated for one emulated device, e.g., to emulate a device that is infected with more than one type of malware.

After generating the network traffic, the network traffic emulator 220 causes transmission of both the benign and malicious network traffic, e.g., in accordance with the corresponding benign and malicious traffic transmission models. For example, the network traffic emulator 220 may transmit both the benign and malicious network traffic using a Poisson distribution model for both types of network traffic. The destination of the network packets may vary, e.g., based on the destinations generated when the network traffic was generated by the traffic generation models.

While not depicted in the example data flow 200, the transmitted network traffic may be inspected by one or more devices designed to monitor a network for malicious activity. For example, the network traffic emulator may be placed in an enterprise network that uses an intrusion detection device for sniffing network packets that move within and/or outside of the enterprise's network. In a situation where the network traffic emulator uses a DGA as a malicious traffic generation model, the effectiveness of the intrusion detection device attached to the network may be evaluated, e.g., based on whether or not the intrusion detection device detects the DGA usage and/or how quickly it detects the use of a DGA.

The example data flow 200 depicts one example implementation of network traffic emulation. Additional or different devices and data flows may also be used to emulate network traffic. For example, an administrative device 210 may not be used in some implementations. As another example, the network traffic emulator 220 may comprise multiple computing devices operating in parallel. Models for benign and malicious network traffic may be provided by a third party user or device, and/or provided to the network traffic model data 230 in advance.

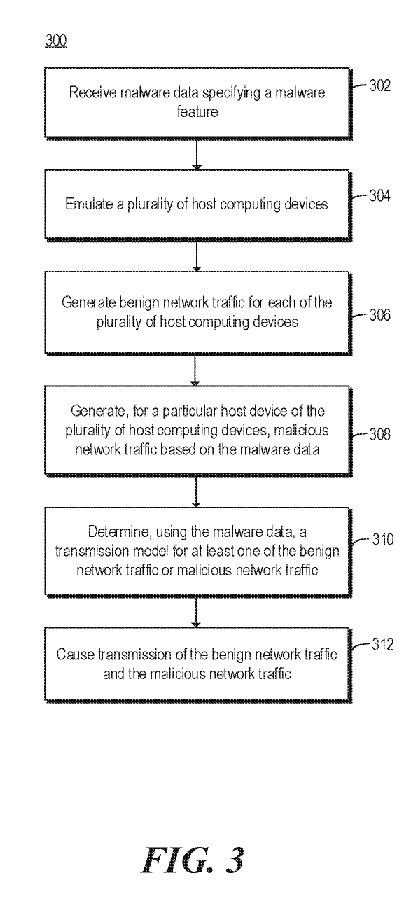

FIG. 3 is a flowchart of an example method 300 for emulating network traffic. The method 300 may be performed by a computing device, such as a computing device described in FIG. 1. Other computing devices may also be used to execute method 300. Method 300 may be implemented in the form of executable instructions stored on a machine-readable storage medium, such as the storage medium 130, and/or in the form of electronic circuitry, such as an FPGA or ASIC.

Malware data is received that specifies a malware feature (block 302). Malware data may be received from a user or a separate input device, and the malware feature generally provides some indication as to what type of malware is to be emulated. Malware features may indicate or specify a particular type of attack, such as a data exfiltration attack, a crypto-locker attack, a data manipulation attack, a DoS/DDoS attack, and/or a data defacement attack. The malware data may include a variety of other information, such as a number of computing devices to emulate, a number of devices to be infected, and data relating to the manner in which emulated network traffic is to be transmitted, such as parameters defining a network traffic volume and/or throughput for benign and/or malicious network traffic.

A plurality of host computing devices are emulated (block 304). For example, IP addresses, MAC addresses, and/or other device identifying data may be generated or spoofed, enabling creation of network traffic that appears to be coming from separate hardware devices. Other forms of emulation, such as virtual machines, or separate hardware machines, may also be used to emulate multiple computing devices. The actual type of host computing devices may vary, e.g., from personal computers to mobile devices and/or networking hardware such as switches.

Benign network traffic is generated for each of the plurality of host computing devices (block 306). In some implementations, benign network traffic is generated using a benign network traffic model. Benign network traffic models may be created in a variety of ways, e.g., based on previously recorded network traffic, using whitelisted network traffic, or manual input of known benign types of network traffic.

For a particular host device of the plurality of host computing devices, malicious network traffic is generated based on the malware data (block 308). The malware feature, and other information included in the malware data in situations where such additional malware information is specified, may be used to determine what type of attack will be emulated and what manner of malicious network traffic will be generated. For example, for a malware type that attempts to spread by internal executable distribution within email, block 308 may cause generation of SMTP traffic that includes a malicious executable; or an executable with a malicious signature. In some implementations, an attack or attack feature may be randomly selected from available attack models.

Using the malware data, a transmission model is determined for at least one of the benign network traffic or malicious network traffic (block 310). For example, the malware data; which specifies a feature of and/or the type of attack, may cause the use of a certain type of transmission model. In the example attack above where malware attempts to spread internally via an executable sent using SMTP, a transmission model for this type of attack pattern may be identified, e.g., a model that indicates such executables should be sent periodically over time, in an effort to avoid detection, or in a burst, in an effort to infect as many other devices as quickly as possible.

The benign network traffic and the malicious network traffic is transmitted (block 312). Transmission of both forms of emulated network traffic may be accomplished by a device on which the method 300 is run, or separate devices may be instructed to perform transmission of the emulated network traffic. In a situation where transmission models are used, the transmission of the benign and malicious network traffic may take place according to the transmission models.

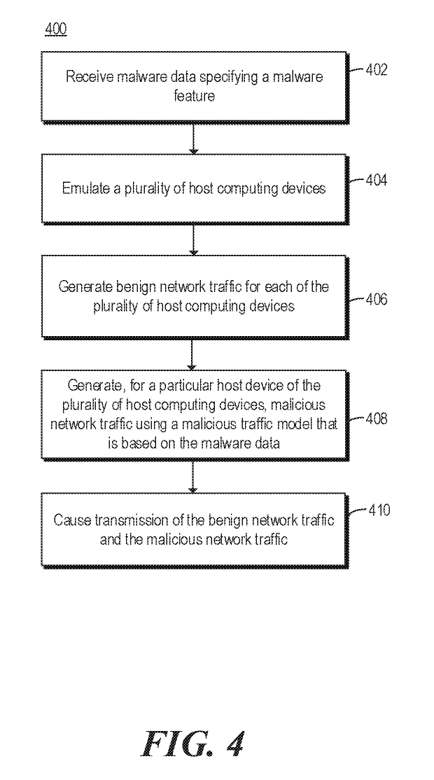

FIG. 4 is a flowchart of an example method 400 for the emulation of network traffic. The method 400 may be performed by a computing device, such as a computing device described in FIG. 1. Other computing devices may also be used to execute method 400. Method 400 may be implemented in the form of executable instructions stored on a machine-readable storage medium, such as the storage medium 130, and/or in the form of electronic circuitry, such as an FPGA or ASIC.

Malware data is received that specifies a malware feature (block 402). Malware data may be received from a user or a separate input device, and the malware feature generally provides some indication as to what type of malware is to be emulated. The malware feature may indicate, for example, a data exfiltration attack, a crypto-locker attack, an attack that uses a DGA, and/or a randomly selected attack from available attack models. The malware data may include a variety of other information, such as a number of computing devices to emulate, a number of devices to be infected, and data relating to the manner in which emulated network traffic is to be transmitted, such as parameters defining a network traffic volume and/or throughput for benign and/or malicious network traffic.

A plurality of host computing devices are emulated (block 404). For example, IP addresses, MAC addresses, and/or other device identifying data may be generated or spoofed, enabling creation of network traffic that appears to be coming from separate hardware devices. Other forms of emulation, such as virtual machines, or separate hardware machines, may also be used to emulate multiple computing devices. The actual type of host computing devices may vary, e.g., from personal computers to mobile devices and/or networking hardware such as switches.

Benign network traffic is generated for each of the plurality of host computing devices (block 406). In some implementations, benign network traffic is generated using a benign network traffic model. Benign network traffic models may be created in a variety of ways, e.g., based on previously recorded network traffic, using whitelisted network traffic, or manual input of known benign types of network traffic.

For a particular host device of the plurality of host computing devices, malicious network traffic is generated using a malicious traffic model that is based on the malware data (block 408). The malware feature included in the malware data, and/or other information included in the malware data in situations where such additional malware information is specified, may be used to determine a malicious traffic model that can be used to generate malicious network traffic. For example, a malicious attack that attempts to exfiltrate data may use period bursts of network packets with payload data being exfiltrated.

The benign network traffic and the malicious network traffic is transmitted (block 410). A transmission model may, in some implementations, be used for at least one of the benign network traffic or malicious network traffic. For example, the malware data, which specifies a feature and/or the type of attack, may cause the use of a certain type of transmission model. In the example attack above where malware attempts to exfiltrate data, a transmission model for this type of attack pattern may be identified, e.g., a model that causes payload data to be sent in periodic bursts or a steady stream of data, in an effort designed to exfiltrate information without being detected or as quickly as possible before the malware is detected.

As with method 300, transmission of both forms of emulated network traffic may be accomplished by a device on which the method 400 is run, or separate devices may be instructed to perform transmission of the emulated network traffic. In a situation where transmission models are used, the transmission of the benign and malicious network traffic may take place according to the transmission models.

While the methods 300 and 400 are described with respect to a single computing device, various portions of the methods may be performed by other computing devices. For example, one computing device may be responsible for generating network traffic, while another computing device may be responsible for transmitting the network traffic.

The foregoing disclosure describes a number of example implementations for emulating network traffic. As detailed above, examples provide a mechanism for using known information about malicious and benign network traffic emulate network traffic capable of emulating network of computing devices experiencing an attack.

We claim:

1. A non-transitory machine-readable storage medium encoded with instructions executable by a hardware processor of a computing device for emulating network traffic, the machine-readable storage medium comprising instructions to cause the hardware processor to:
receive malware data specifying a malware feature;
emulate a plurality of host computing devices;
generate benign network traffic for each of the plurality of host computing devices;
for a particular host device of the plurality of host devices, generate malicious network traffic based on the malware data; and
cause transmission of the benign network traffic and the malicious network traffic.

2. The storage medium of claim 1, wherein:
the benign network traffic is generated according to a benign traffic model; and
the malicious network traffic is generated according to a malicious traffic model.

3. The storage medium of claim 2, wherein:
the benign traffic model is based on previously recorded benign network traffic.
the malicious traffic model is based on previously recorded malicious activity.

4. The storage medium of claim 1, wherein:
transmission of the benign network traffic is performed according to a benign traffic transmission model; and
transmission of the malicious network traffic is performed according to a malicious traffic transmission model.

5. The storage medium of claim 4, wherein:
the benign traffic transmission model is based on a transmission pattern of previously recorded benign network traffic; and
the malicious traffic transmission model is based on a transmission pattern of previously recorded malicious network traffic.

6. The storage medium of claim 1, wherein the malware data includes parameters specifying:
a number of the plurality of host computing devices for which malicious network traffic is generated;
a network traffic volume for at least one of the benign network traffic or the malicious network traffic; and
transmission data indicating a manner in which at least one of the benign network traffic or the malicious network traffic is transmitted.

7. The storage medium of claim 1, wherein:
the malware feature includes a domain generation algorithm; and
the malicious network traffic is generated using the domain generation algorithm.

8. A computing device for emulating network traffic, the computing device comprising:
a hardware processor; and
a data storage device storing instructions that, when executed by the hardware processor, cause the hardware processor to:
receive malware data specifying a malware feature;
emulate a plurality of host computing devices;
generate benign network traffic for each of the plurality of host computing devices;
for a particular host device of the plurality of host computing devices, generate malicious network traffic based on the malware data;
determine, using the malware data, a transmission model for transmitting at least one of the benign network traffic or the malicious network traffic; and
cause transmission of the benign network traffic and the malicious network traffic.

9. The computing device of claim 8, wherein:
the benign network traffic is generated according to a benign traffic model; and
the malicious network traffic is generated according to a malicious traffic model.

10. The computing device of claim 9, wherein:
the benign traffic model is based on previously recorded benign network traffic; and
the malicious traffic model is based on previously recorded malicious activity.

11. The computing device of claim 8, wherein the transmission model is a benign traffic transmission model for transmission of the benign network traffic, and wherein the instructions further cause the hardware processor to:
determine, using the malware data, a malicious traffic transmission model for transmission of the malicious network traffic; and
cause transmission of the malicious network traffic using the malicious traffic transmission model.

12. The computing device of claim 11, wherein:
the benign traffic transmission model is based on a transmission pattern of previously recorded benign network traffic; and
the malicious traffic transmission model is based on a transmission pattern of previously recorded malicious network traffic.

13. The computing device of claim 8, wherein the malware data includes parameters specifying:
a number of the plurality of host computing devices for which malicious network traffic is generated; and
a network traffic volume for at least one of the benign network traffic or the malicious network traffic.

14. The computing device of claim 8, wherein:
the malware feature includes data exfiltration; and
the transmission model causes transmission of the malicious network traffic in multiple bursts over time.

15. A method for emulating network traffic, implemented by a hardware processor, the method comprising:
receiving malware data specifying a malware feature;
emulating a plurality of host computing devices;
generating benign network traffic for each of the plurality of host devices;
for a particular host device of the plurality of host devices, generating malicious network traffic using a malicious traffic model that is based on the malware data; and
causing transmission of the benign network traffic and the malicious network traffic.

16. The method of claim 15, wherein the benign network traffic is generated according to a benign traffic model.

17. The method of claim 16, wherein:
the benign traffic model is based on previously recorded benign network traffic,
the malicious traffic model is based on previously recorded malicious activity.

18. The method of claim 15, wherein:
transmission of the benign network traffic is performed according to a benign traffic transmission model; and
transmission of the malicious network traffic is performed according to a malicious traffic transmission model.

19. The method of claim 18, wherein:
the benign traffic transmission model is based on a transmission pattern of previously recorded benign network traffic; and
the malicious traffic transmission model is based on a transmission pattern of previously recorded malicious network traffic.

20. The method of claim 15, wherein the malware data includes parameters specifying:
a number of the plurality of host computing devices for which malicious network traffic is generated;
a network traffic volume for at least one of the benign network traffic or the malicious network traffic; and
transmission data indicating a manner in which at least one of the benign network traffic or the malicious network traffic is transmitted.
